(19) United States
(12) Patent Application Publication
(10) Pub. No.: US 2007/0056103 A1
(43) Pub. Date: Mar. 15, 2007

(54) Medical examination table having configurable drawers

(75) Inventors: Scott T. Magoteaux, Versailles, OH (US); Arthur D. Smith, Greenville, OH (US); Jon Wells, New Bremen, OH (US)

Correspondence Address: WOOD, HERRON & EVANS, LLP, 2700 CAREW TOWER, 441 VINE STREET, CINCINNATI, OH, 45202, US

(73) Assignee: Midmark Corporation

(21) Appl. No.: 11/226,813

(22) Filed: Sep. 14, 2005

(51) Int. Cl. A61G 13/10

(52) U.S. Cl. 5/600; 5/308

(57) ABSTRACT

A medical examination table includes a pass-through storage drawer which is accessible from either side of the examination table through opposite drawer openings. A drawer front is releasably connected adjacent either end of the drawer to change the access side of the examination table. A cover member is provided to cover the drawer openings on the non-access side of the examination table.

### FIELD OF THE INVENTION

The present invention relates generally to medical examination tables and, more particularly, to a storage drawer of a medical examination table for storing items and supplies within the drawer.

### BACKGROUND OF THE INVENTION

Medical examination tables are known to have a patient supporting surface comprising a seat section and an adjustable back section supported by a base of the examination table. The back section is movable between a horizontal position and an inclined position so that a patient is supported in an upright position during certain medical examination procedures.

Medical examination tables typically have storage drawers mounted in the base of the examination table for storing medical supplies, instruments or any other items that may be required during an examination procedure. In the past, medical examination tables have been typically manufactured to provide access to the storage drawers from only one or the other side of the examination table. In the event the examination table was moved to a different location of the examination area, the access side to the storage drawers of the examination table was fixed and could not be changed.

Also, it was oftentimes difficult to change the style, configuration or color of the drawers to match a new decor in the examination area since this required removal and replacement of the storage drawers which is costly and time consuming.

Accordingly, there is a need for a storage drawer for use in a medical examination table which overcomes these and other drawbacks of the prior art.

### SUMMARY OF THE INVENTION

The present invention overcomes the foregoing and other shortcomings and drawbacks of storage drawers heretofore known for use in a medical examination table. While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a medical examination table is provided with one or more configurable pass-through drawers supported in a base of the examination table. The pass-through drawers are configurable to be opened from either the right or left side of the medical examination table. The drawers are extendable and retractable through drawer openings provided in opposite side walls of the base.

According to one aspect of the present invention, a drawer front is provided to be releasably connected adjacent opposite ends of the drawer to configure the drawer to be accessible from either the right or left side of the examination table. The drawer and drawer front have cooperating locking structure to releasably connect the drawer front and drawer together.

According to another aspect of the present invention, a cover member is provided to be secured to the non-access side of the examination table to cover the drawer openings on that side of the examination table. The base and cover member have cooperating locking structure to releasably connect the cover member to the non-access side of the examination table.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a perspective view of an exemplary medical examination table showing pass-through drawers supported in a base of the examination table in accordance with the one aspect of the present invention;

FIG. 1A is a view similar to FIG. 1 showing drawer fronts releasably connected adjacent respective end walls of the drawers in accordance with the another aspect of the present invention;

FIG. 1B is a view similar to FIG. 1 showing a cover member releasably connected to a side wall of the base in accordance with yet another aspect of the present invention;

FIG. 2A is a partial cross sectional view showing one of the pass-through doors of FIG. 1;

FIG. 2B is a view similar to FIG. 2A showing a drawer front releasably connected adjacent one of the end walls of the drawer shown in FIG. 2A and a cover member releasably connected to one of the side walls of the base;

FIG. 2C is a view similar to FIG. 2B showing a drawer front releasably connected to an opposite end wall of the drawer shown in FIG. 2B and a cover member releasably connected to an opposite side wall of the base;

FIG. 3 is a partial cross sectional view showing multiple drawer fronts releasably connected adjacent respective end walls of multiple drawers and a cover member connected to a side wall of the base;

FIG. 3A is a partial cross sectional view showing releasable connection of the cover member to a side wall of the base;

FIG. 3B is a partial cross sectional view showing releasable connection of a drawer front adjacent one end wall of a drawer; and

FIG. 4 is a partial bottom view of a drawer and a drawer front showing cooperating locking structure provided on the drawer and the drawer front for releasably connecting the drawer front adjacent one end wall of the drawer.

### DETAILED DESCRIPTION OF THE PREFERRED EMBODIMENT

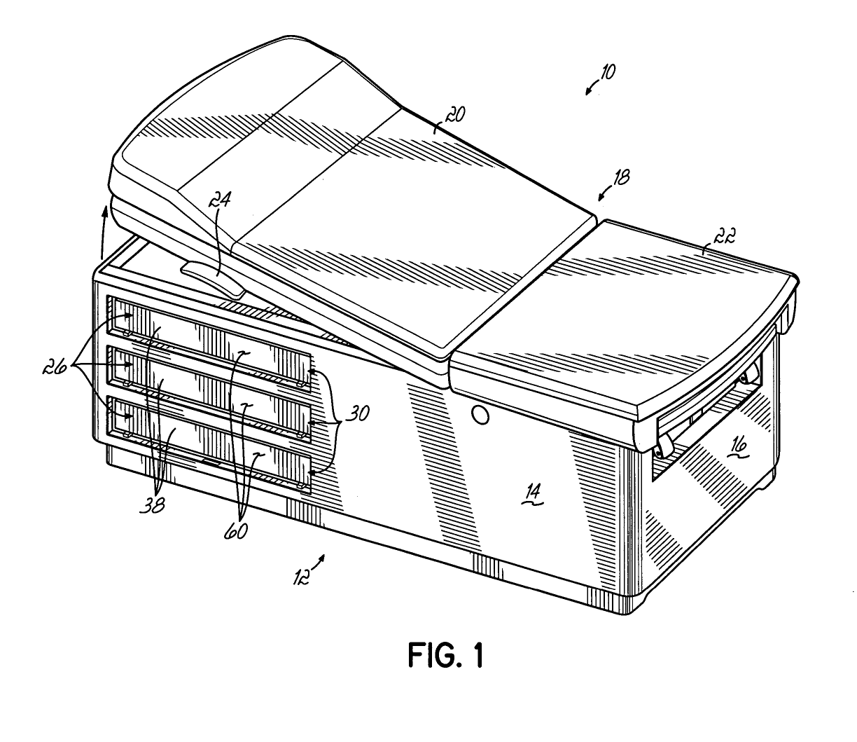

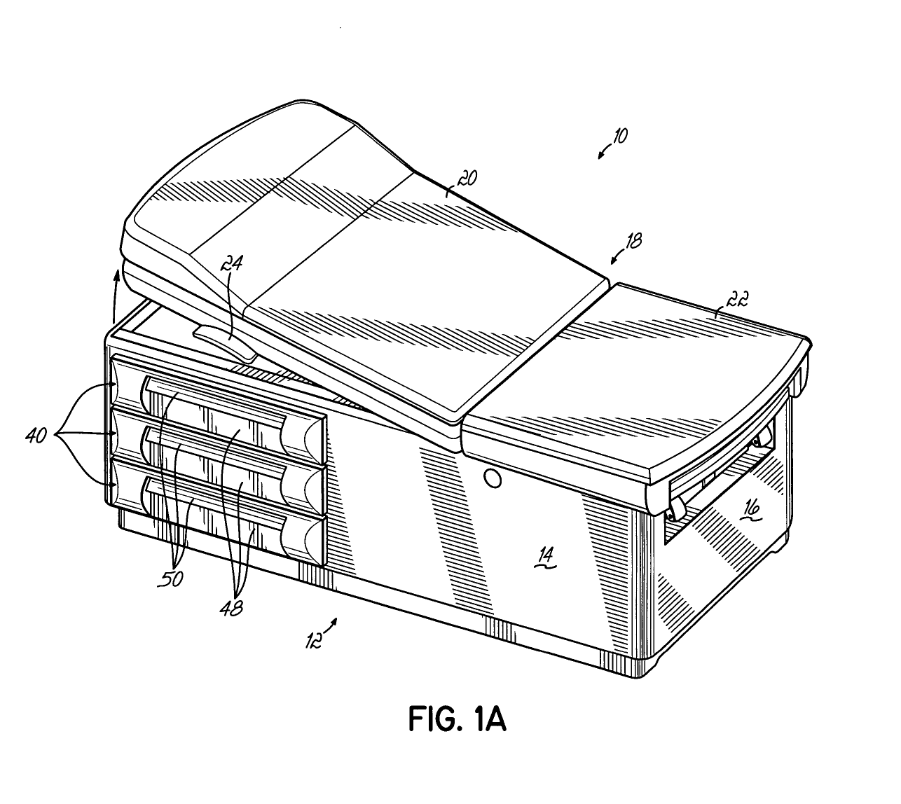

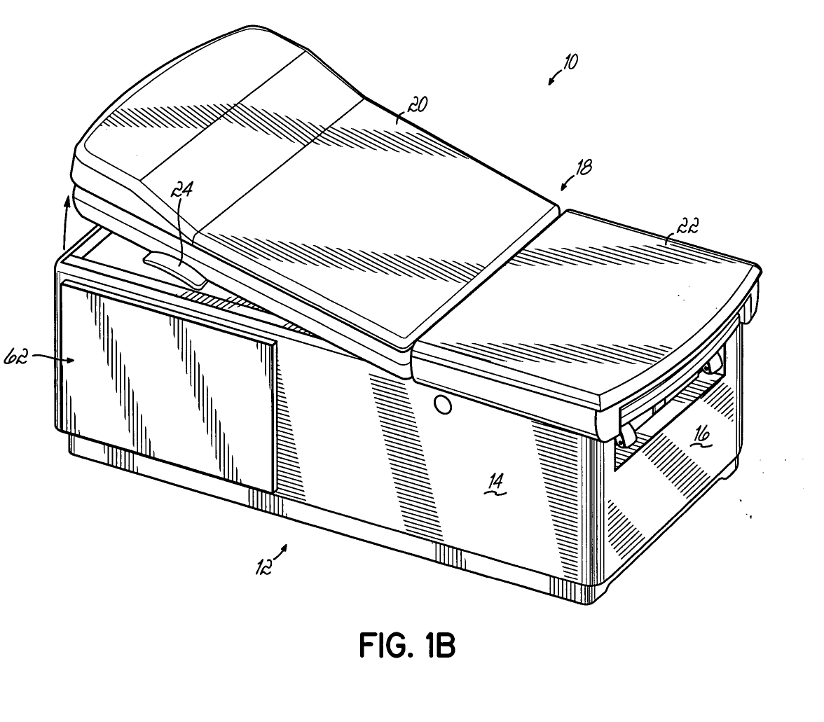

Referring to FIG. 1, an exemplary medical examination table 10 is shown including a base 12 having a pair of opposite side walls 14 and a pair of opposite ends walls 16. In one embodiment, a patient support 18, including a back section 20 and a seat section 22, is supported by the base 12. The back section 20 is movable relative to the seat section 22 and the base 12 between an inclined orientation for supporting a patient in a seated position and a fully reclined orientation for supporting the patient in a generally supine position. In one embodiment, the position of the back section 20 is controlled through an adjustment mechanism 24 that is operatively connected between the base 12 and a back section 20. The adjustment mechanism 24 permits the back section 20 to be manually moved to a desired orientation and thereafter locked in place until the back section 20 is moved again to readjust the patient. Those of ordinary skill in the art will appreciate that other types of adjustment mechanisms are possible as well without departing from the spirit and scope of the present invention.

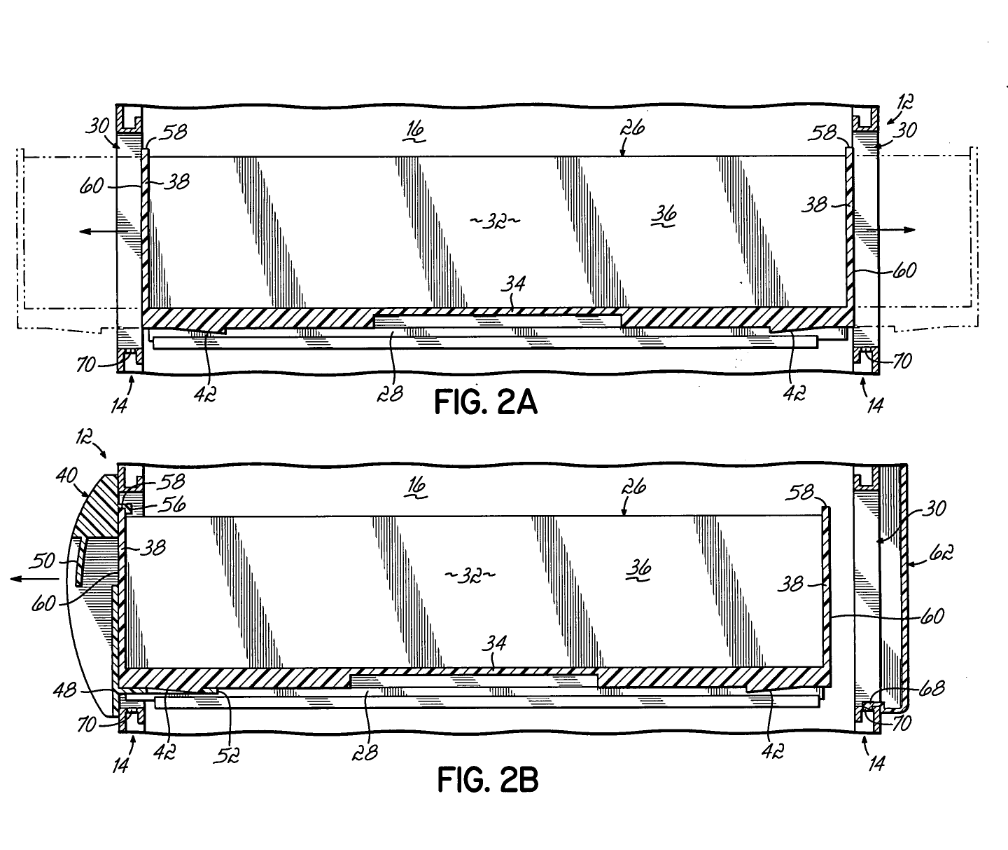

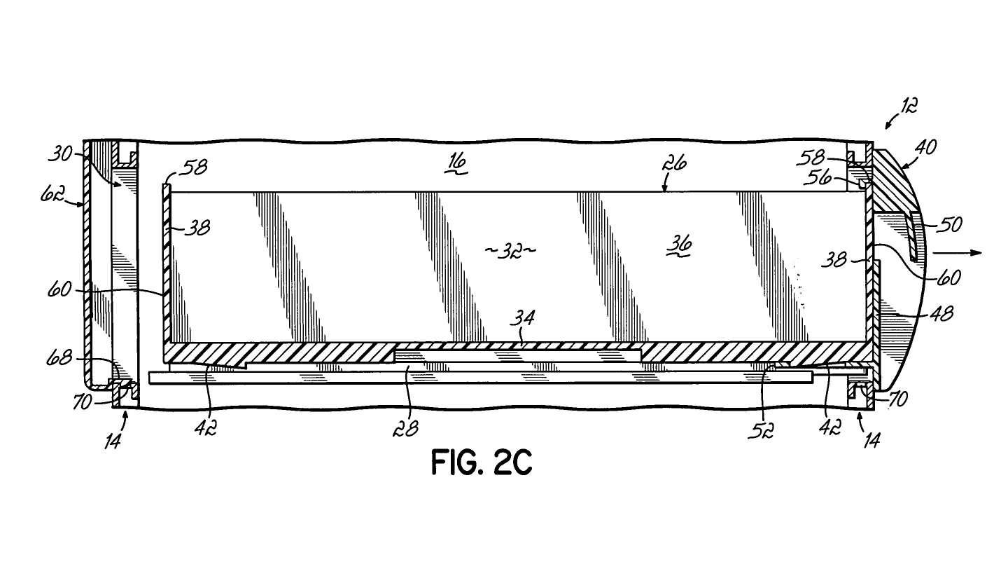

In accordance with one aspect of the present invention, one or more configurable pass-through drawers 26 are supported in the base 12 as shown in FIGS. 1, 1A, 2A-C and 3. The pass-through drawers 26 are configurable to be opened from either the right or left side of the medical examination table 10 as will be described in great detail below. As used herein, “right” or “left” side is intended to correspond to the orientation a person facing the examination table adjacent the seat section 22.

In one embodiment, the pass-through drawers 26 are slidably supported on bearing assemblies 28 provided beneath the drawers 26. The drawers 26 are extendable and retractable through a pair of drawer openings 30 provided in the opposite side walls 14 of the base 12. The pass-through drawers 26 are extendable outwardly beyond either of the side walls 14 of the base 12 when the drawer 26 is opened from either the left or right side of the medical examination table 10 as shown in FIG. 2A.

Each drawer 26 has a storage interior 32 defined by a bottom wall 34, a pair of opposite side walls 36, and a pair of opposite ends walls 38 extending between the pair of side walls 36. The storage interior 32 of the drawer 26 may be used to store medical supplies, instruments or any other items that may be required during an examination procedure as will be appreciated by those skilled in the art. In one embodiment, the drawer 26 is molded of a polymeric or other suitable material as an integral component, although it will be appreciated that the drawer 26 may comprise separate components that are secured together in a known manner to form the drawer 26.

In accordance with another aspect of the present invention, as shown in FIGS. 2B-C, a drawer front 40 is provided to be releasably connected adjacent either end wall 38 of the drawer 26 to configure the drawer 26 to be accessible from either the left or right side of the examination table 10. As shown in FIG. 2B, the drawer 26 is configured to be opened from the left side of the examination table 10. When the drawer front 40 is removed and connected adjacent the opposite end wall 38 of the drawer 26 as shown in FIG. 2C, the drawer 26 is now configured to be opened from the right side of the examination table 10.

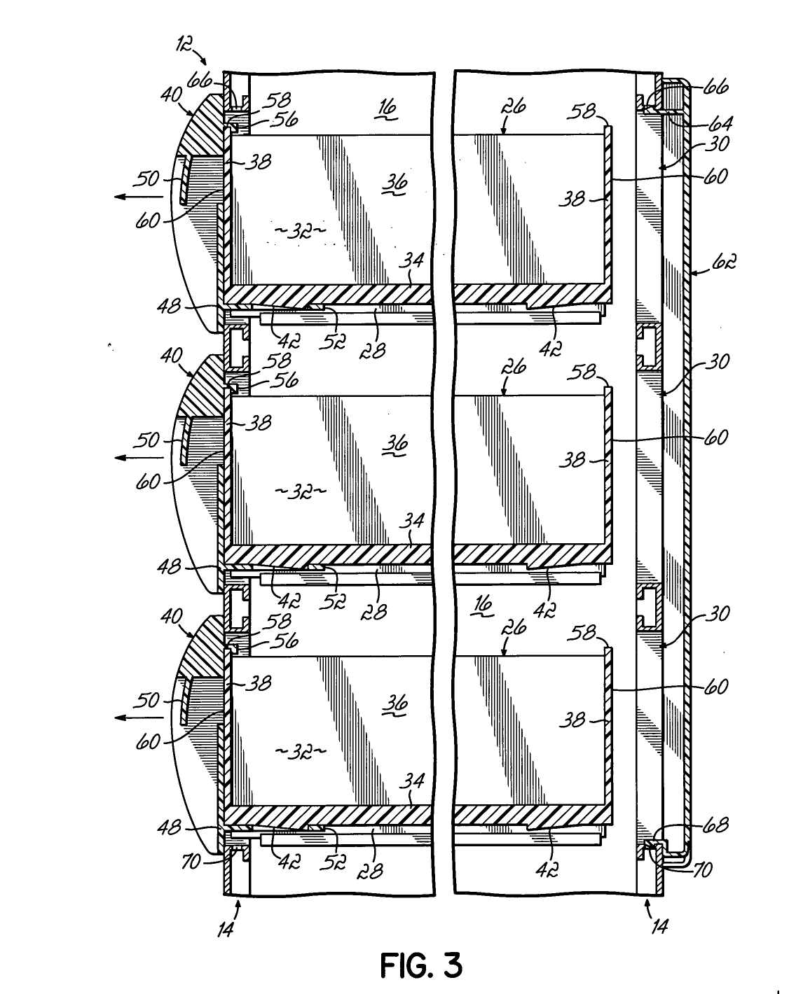

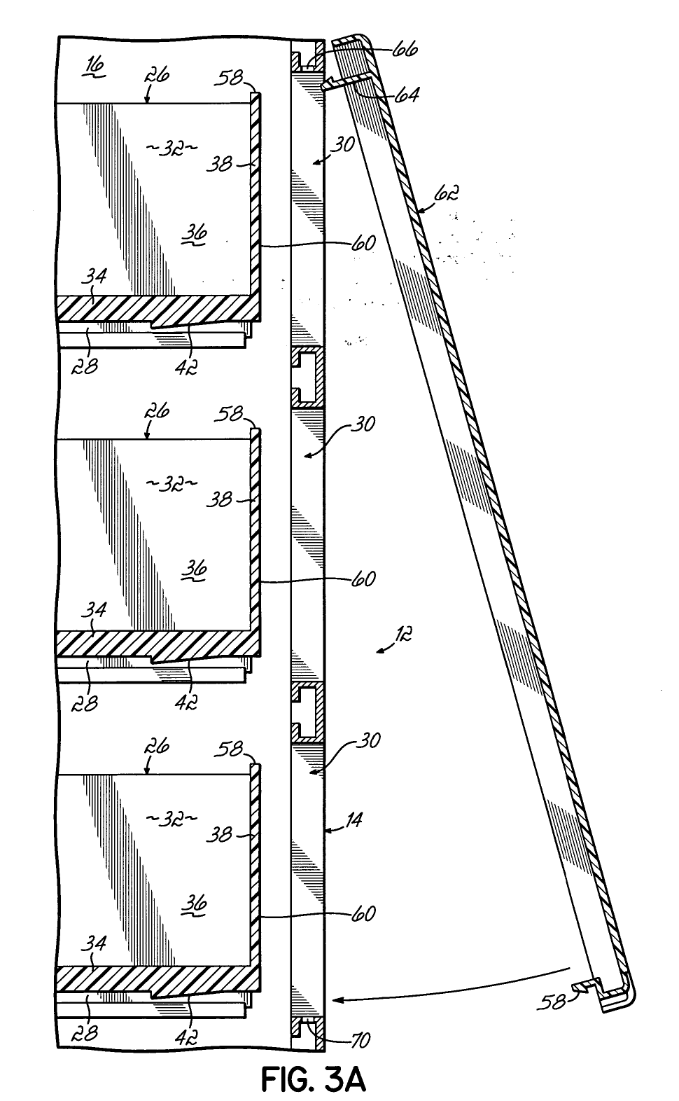

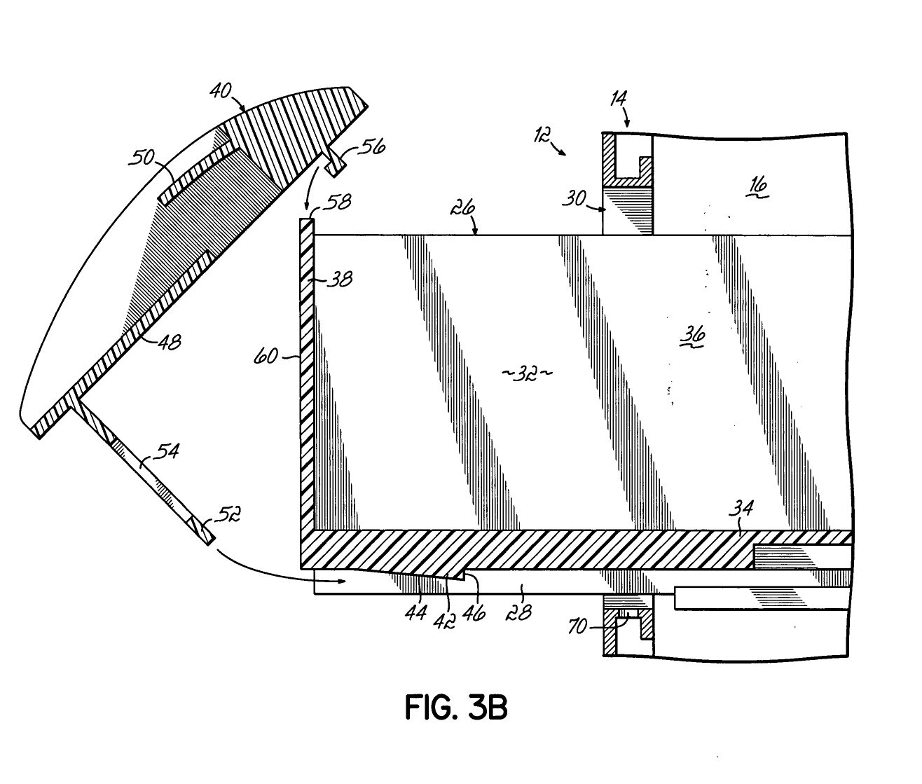

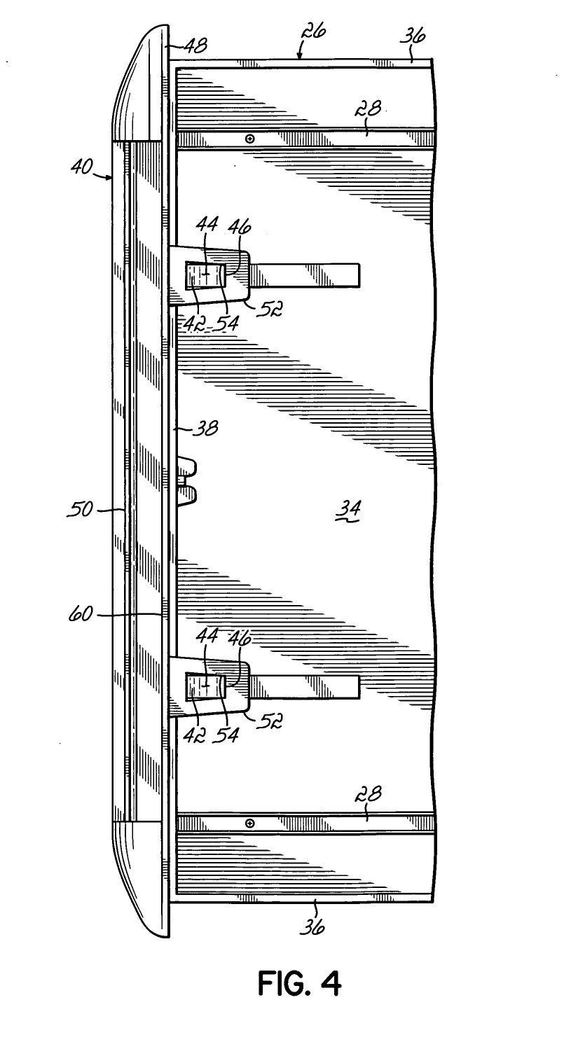

In one embodiment as shown in FIGS. 3B and 4, the drawer 26 includes one or more barbs 42 that extend outwardly from the bottom wall 34 of the drawer 26 generally adjacent each of the end walls 38 of the drawer 26. In one embodiment as shown in FIG. 4, a pair of spaced apart barbs 42 extend outwardly from the bottom wall 34 of the drawer 26 generally adjacent each of the end walls 38 of the drawer 26. Each barb 42 includes a ramp wall 44 (FIG. 3B) that progressively increases in height in a direction toward the center of the drawer 26 and terminates at an abrupt wall 46 (FIG. 3B) that extends generally perpendicular to the bottom wall 34.

As shown in FIGS. 3B and 4, the drawer front 40 includes a generally flat rear wall 48 that lies adjacent an end wall 38 of the drawer 26 when the drawer front 40 is releasably connected to the drawer 26 in accordance with the principles of the present invention. In one embodiment, the drawer front 40 is molded from a polymeric or other suitable material as a single component. A handle 50 (FIGS. 3B and 4) is provided on the drawer front 40 to permit a user to grasp the drawer front 40 for opening or closing of the drawer 26 from the right or left side of the examination table 10. It will be appreciated that the drawer front 40 may be manufactured in a variety of styles, shapes and colors for changing the appearance of the medical examination table 10 while the pass-through drawers 26 remain unchanged.

Further referring to FIGS. 3B and 4, the drawer front 40 has one or more resilient tabs 52 that extend outwardly from a lower portion of the rear wall 48 of the drawer front 40 in a direction generally perpendicular to the rear wall 48. Each resilient tab 52 has a slot 54 formed therein that is configured to engage, in a “snap fit” locking manner, a respective barb 42 when the drawer front 40 is secured to the drawer 26 as will be described in detail below. The drawer front 40 also includes a flange 56 extending outwardly from an upper portion of the rear wall 48. The flange 56 is configured to engage a lip 58 defined by an upper free edge of the opposite end walls 38 of the drawer 26 as will be described in detail below.

During installation of the drawer front 40 to a drawer 26, the flange 56 is engaged with the lip 58 of one of the end walls 38 as shown in FIG. 3B. The drawer front 40 is then hinged downwardly so that the resilient tabs 52 ride upon the ramp walls 44 of the barbs 42 until the slots 54 capture the barbs 42 in a “snap fit” as shown in FIG. 4. In this position, the drawer front 40 is held tightly against an outer drawer face 60 (FIG. 3B) of the drawer 26.

To remove the drawer front 40 from the drawer 26, the resilient tabs 52 are first pulled downwardly to release the barbs 42 from the slots 54. Thereafter, the drawer front 40 is hinged upwardly to disengage the flange 56 from the lip 58. In this way, the drawer fronts 40 can be easily removed and placed on the opposite side of the examination table 10 to change the access side of the table 10. Alternatively, the drawer fronts 40 can be easily removed and replaced with drawer fronts having a different style, shape or color for changing the appearance of the medical examination table 10.

In accordance with another aspect of the present invention, a cover member 62 is provided to be secured to the non-access side of the base 12 to cover the drawer openings 30 on the non-access side of the examination table 10 a shown in FIGS. 1B, 3 and 3A. In one embodiment, the cover member 62 includes one or more hooks 64 extending outwardly from an upper portion of the cover member 62. The hooks 64 are engageable in complimentary slots 66 formed in an upper portion of the side walls 14 of the base 12. The cover member 62 also includes a manually actuatable latch 68 provided in a lower portion of the cover member 62. The latch 68 is engageable in a complementary slot 70 formed in a lower portion of the side walls 14.

During installation of the cover member 62 to the non-access side of the examination table 10, the hooks 64 are first engaged with the slots 66 as shown in FIG. 3A. The cover member 62 is then hinged downwardly so that the latch 68 is received in slot 70 in a “snap fit.” In this way, the drawer openings 30 located on the non-access side of the examination table 10 are covered by the cover member 62.

To remove the cover member 62 from the non-access side of the examination table 10, the latch 68 is first manually actuated to disengage the latch 68 from the slot 70. Thereafter, the cover member 62 is hinged upwardly to disengage hooks 64 from the slots 66. In this way, the cover member 62 can be easily removed and placed on the opposite side of the examination table 10 when the access side of the table 10 is changed.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of Applicants' general inventive concept.

Having described the invention, we claim:

1. A medical examination table, comprising:
a base having a pair of opposite side walls;
a patient support surface supported by the base;
a pass-through drawer supported in the base and having a storage interior defined by a bottom wall, a pair of opposite side walls and a pair of opposite end walls extending between the pair of side walls of the drawer, the drawer being supported so as to be extendable outwardly beyond either of the pair of side walls of the base to provide user access to the storage interior of the drawer; and
a drawer front configured to be releasably connected adjacent either of the pair of end walls of the drawer.

2. The medical examination table of claim 1 further comprising a pair of opposite drawer openings provided in the side walls of the base, the drawer being extendable outwardly from either of the pair of drawer openings.

3. The medical examination table of claim 2 further comprising a cover member configured to be releasably connected to either of the side walls of the base and cover either of the pair of drawer openings.

4. The medical examination table of claim 1 further comprising a plurality of drawers supported in the base, each of the drawers having a storage interior defined by a bottom wall, a pair of opposite side walls and a pair of opposite end walls extending between the pair of side walls of the drawer, each of the drawers being supported so as to be extendable outwardly beyond each of the pair of side walls of the base to provide user access to the storage interior of the drawer.

5. The medical examination table of claim 4 further comprising a plurality of drawer fronts configured to be releasably connected adjacent either of the pair of end walls of a respective drawer.

6. The medical examination table of claim 4 further comprising a plurality of opposite drawer openings provided in the side walls of the base, each drawer being extendable outwardly from either of a respective pair of opposite drawer openings.

7. The medical examination table of claim 6 further comprising a cover member configured to be releasably connected to either of the side walls of the base and cover the plurality of drawer openings provided in either of the side walls of the base.

8. The medical examination table of claim 1 wherein the drawer and the drawer front have cooperating locking structure configured to releasably connect the drawer front to either of the pair of end walls of the drawer.

9. The medical examination table of claim 8 wherein the drawer has at least one projection extending outwardly from the bottom wall of the drawer generally adjacent each of the pair of end walls of the drawer and the drawer front has a resilient tab extending outwardly therefrom configured to releasably engage either of the projections.

10. The medical examination table of claim 9 further comprising:
a lip defined by a free edge of each of the end walls of the drawer; and
a flange extending from the drawer front and configured to engage either of the lips of each end wall.

11. The medical examination table of claim 3 wherein the base and the cover have cooperating locking structure configured to releasably connect the cover to either of the pair of side walls of the base.
